(19) United States
(12) Patent Application Publication
(10) Pub. No.: US 2022/0231327 A1
(43) Pub. Date: Jul. 21, 2022

(54) SULFIDE SOLID ELECTROLYTE, PRECURSOR, ALL SOLID STATE BATTERY AND METHOD FOR PRODUCING SULFIDE SOLID ELECTROLYTE

(71) Applicant: TOYOTA JIDOSHA KABUSHIKI KAISHA, Toyota-shi (JP)

(72) Inventor: Keiichi MINAMI, Tagata-gun (JP)

(73) Assignee: TOYOTA JIDOSHA KABUSHIKI KAISHA, Toyota-shi (JP)

(21) Appl. No.: 17/540,583

(22) Filed: Dec. 2, 2021

(30) Foreign Application Priority Data
Jan. 19, 2021 (JP) 2021-006201

(51) Int. Cl. H01M 10/0562

(52) U.S. Cl. CPC H01M 10/0562

(57) ABSTRACT

A main object of the present disclosure is to provide a sulfide solid electrolyte having excellent ion conductivity and water resistance. The present disclosure achieves the object by providing a sulfide solid electrolyte comprising Li, P, S and CO₃²⁻; wherein the sulfide solid electrolyte includes a crystal phase with Li₇P₃S₁₁ structure as a main phase; in an X-ray diffraction measurement using a CuKα ray, when I_{A} designates a peak intensity of Li₂S that appears at the position of 2θ=27.0°±0.5°, and I_{B} designates a peak intensity of the crystal phase that appears at the position of 2θ=23.65°±0.50°, I_{A}/I_{B} is 0 or more and 0.39 or less; and a peak of a heterogeneous phase that appears at the position of 2θ=16.5°±0.5° is not included.

### TECHNICAL FIELD

The present disclosure relates to a sulfide solid electrolyte having excellent ion conductivity and water resistance.

### BACKGROUND ART

An all solid state battery is a battery including a solid electrolyte layer between a cathode layer and an anode layer, and one of the advantages thereof is that the simplification of a safety device may be more easily achieved compared to a liquid-based battery including a liquid electrolyte containing a flammable organic solvent. Also, as a solid electrolyte used for an all solid state battery, a sulfide solid electrolyte has been known.

For example, Patent Literature 1 discloses a sulfide solid electrolyte with Li₇P₃S₁₁ structure. In particular, Patent Literature 1 discloses a so-called Li₂S—P₂S₅-based sulfide solid electrolyte using Li₂S and P₂S₅ as raw materials.

### CITATION LIST

### Patent Literature

Patent Literature 1: Japanese Patent Application Laid-Open (JP-A) No. 2019-053850

### SUMMARY OF DISCLOSURE

### Technical Problem

There are rooms for improvement of water resistance of the Li₂S—P₂S₅-based sulfide solid electrolyte since its sulfur content is a lot on the contrary of its excellent ion conductivity. The present disclosure has been made in the view of the above circumstances, and a main object thereof is to provide a sulfide solid electrolyte having excellent ion conductivity and water resistance.

### Solution to Problem

In order to achieve the object, the present disclosure provides a sulfide solid electrolyte comprising Li, P, S and CO₃²⁻; wherein the sulfide solid electrolyte includes a crystal phase with Li₇P₃S₁₁ structure as a main phase; in an X-ray diffraction measurement using a CuKα ray, when I_{A} designates a peak intensity of Li₂S that appears at the position of 20=27.0°±0.5°, and I_{B} designates a peak intensity of the crystal phase that appears at the position of 20=23.65°±0.50°, I_{A}/I_{B} is 0 or more and 0.39 or less; and a peak of a heterogeneous phase that appears at the position of 20=16.5°±0.5° is not included.

According to the present disclosure, the sulfide solid electrolyte is allowed to have excellent ion conductivity and water resistance since CO₃²% is included, the crystal phase with Li₇P₃S₁₁ structure is included as a main phase, the I_{A}/I_{B} is the specified value or less, and the peak of the heterogeneous phase is not included.

In the disclosure, the molar ratio of the S with respect to the P, which is S/P may be 3.60 or less.

In the disclosure, ion conductivity at 25° C. may be 0.11 mS/cm or more.

The present disclosure also provides a precursor of the above described sulfide solid electrolyte; wherein the precursor contains the Li, the P, the S and the CO₃² and a decarbonation amount measured from a thermal gravimetric—differential thermal analysis is 0.49 weight % or more and 1.36 weight % or less.

According to the present disclosure, the precursor contains CO₃²⁻ and the decarbonation amount is the specified range, and thus the precursor allows to obtain a sulfide solid electrolyte having excellent ion conductivity and water resistance.

The present disclosure also provides an all solid state battery comprising a cathode layer, an anode layer, and a solid electrolyte layer formed between the cathode layer and the anode layer; wherein at least one of the cathode layer, the anode layer, and the solid electrolyte layer contains the above described sulfide solid electrolyte.

According to the present disclosure, usage of the above described sulfide solid electrolyte allows an all solid state battery to have excellent ion conductivity and water resistance.

The present disclosure also provides a method for producing a sulfide solid electrolyte containing Li, P, S and CO₃²⁻, the method comprising: an amorphizing step of conducting a mechanical milling treatment to a raw material composition containing Li₂CO₃ and P₂S₅ to obtain a precursor; and a burning step of burning the precursor to form a crystal phase with Li₇P₃S₁₁ structure.

According to the present disclosure, by using the raw material composition containing Li₂CO₃ and forming the crystal phase with Li₇P₃S₁₁ structure, the sulfide solid electrolyte having excellent ion conductivity and water resistance may be obtained.

In the disclosure, the precursor may contain the Li, the P, the S and the CO₃²⁻, and a decarbonation amount measured from a thermal gravimetric—differential thermal analysis may be 0.49 weight % or more and 1.36 weight % or less.

In the disclosure, the mechanical milling treatment in the amorphizing step may be planetary ball milling, weighing table revolution speed may be 400 rpm or more and 600 rpm or less, and treatment time may be 18 hours or more and 25 hours or less.

In the disclosure, the raw material composition may not contain Li₂S.

### Advantageous Effects of Disclosure

The present disclosure exhibits an effect such that a sulfide solid electrolyte having excellent ion conductivity and water resistance can be provided.

### BRIEF DESCRIPTION OF DRAWINGS

FIG. 1 is a schematic cross-sectional view illustrating an example of the all solid state battery in the present disclosure.

FIG. 2 is a flow chart illustrating an example of the method for producing the sulfide solid electrolyte in the present disclosure.

FIGS. 3A and 3B are respectively the result of an XRD measurement for a sulfide solid electrolyte obtained in Example 3 and Comparative Example 3.

### DESCRIPTION OF EMBODIMENTS

The sulfide solid electrolyte, the precursor, the all solid state battery and the method for producing the sulfide solid electrolyte in the present disclosure are hereinafter explained in details.

A. Sulfide Solid Electrolyte

The sulfide solid electrolyte in the present disclosure is a sulfide solid electrolyte comprising Li, P, S and CO₃² wherein the sulfide solid electrolyte includes a crystal phase with Li₇P₃S₁₁ structure as a main phase; in an X-ray diffraction measurement using a CuKα ray, when I_{A} designates a peak intensity of Li₂S that appears at the position of 20=27.0°±0.5°, and I_{B} designates a peak intensity of the crystal phase that appears at the position of 20=23.65°±0.50°, I_{A}/I_{B} is 0 or more and 0.39 or less; and a peak of a heterogeneous phase that appears at the position of 20=16.5°±0.5° is not included.

According to the present disclosure, the sulfide solid electrolyte is allowed to have excellent ion conductivity and water resistance since CO₃²⁻ is included, the crystal phase with Li₇P₃S₁₁ structure is included as a main phase, the I_{A}/I_{B} is the specified value or less, and the peak of the heterogeneous phase is not included.

As described above, Patent Literature 1 discloses a sulfide solid electrolyte with Li₇P₃S₁₁ structure. In particular, Patent Literature 1 discloses a so-called Li₂S—P₂S₅⁻ based sulfide solid electrolyte using Li₂S and P₂S₅ as raw materials. There are rooms for improvement of water resistance of the Li₂S—P₂S₅-based sulfide solid electrolyte since its sulfur content is a lot on the contrary of its excellent ion conductivity. In specific, there are rooms for improvement of water resistance by reducing hydrogen sulfide generated due to the reaction with water. In contrast, in the sulfide solid electrolyte of the present disclosure, the sulfur content can be reduced since carbonate ion (CO₃²⁻) is included. Therefore, the amount of the hydrogen sulfide can be inhibited from generating, and thus the water resistance improves. Also, the carbonate ion (CO₃²⁻) has ionic radius close to that of sulfide ion (S⁻), and thus the sulfide solid electrolyte containing the carbonate ion is conceived to maintain the Li₇P₃S₁₁ structure. As a result, the ion conductivity also improves. In addition, the sulfide solid electrolyte in the present disclosure can be produced without or reduced amount of Li₂S which is expensive as a raw material, and thus the production cost can be reduced.

It is not clear how the sulfide solid electrolyte in the present disclosure contains the carbonate ion, but it is presumed as follows. First, a typical Li₇P₃S₁₁ crystal phase includes a PS₄³⁻ unit and a P₂S₇⁴⁻ unit (S₃P⁻S⁻PS₃) including a crosslinking sulfur (—S—) in a ratio of PS₄³⁻:P₂S₇⁴⁻=1:1 ((Li₃PS₄+Li₄P₂S₇→Li₇P₃S₁₁). The crosslinking sulfur has low stability with respect to water, and most of the hydrogen sulfide generated is presumably derived from the crosslinking sulfur. Meanwhile, as shown in the later described Examples, in the sulfide solid electrolyte of the present disclosure, the generation amount of the hydrogen sulfur was remarkably little, and it is presumed that the carbonate ion is substituted with at least a part of the crosslinking sulfur in the Li₇P₃S₁₁ crystal phase.

The sulfide solid electrolyte in the present disclosure contains Li, P, S and CO₃²⁻. The sulfide solid electrolyte may contain just Li, P, S and CO₃²⁻, and may contain an additional element. Examples of the additional element may include X (X is halogen). Examples of the halogen may include F, Cl, Br, and I. The X may be just one kind and may be two kinds or more.

The sulfide solid electrolyte in the present disclosure is provided with a crystal phase with Li₇P₃S₁₁ structure (hereinafter also referred to as crystal phase A). The crystal phase A is presumably a crystal phase wherein at least a part of the crosslinking sulfur in the Li₇P₃S₁₁ crystal phase is substituted with carbonate ion. The crystal phase A has peaks at the positions equivalent to the Li₇P₃S₁₁ crystal phase in an X-ray diffraction measurement using a CuKα ray. Typical peaks of the Li₇P₃S₁₁ crystal phase appear at the positions of 2θ=17.8°, 18.2°, 19.8°, 21.8°, 23.8°, 25.9°, 29.5°, and 30.0°. The crystal phase A preferably has peaks at the positions of ±0.5° (preferably at the positions of ±0.3°) of each of the above peaks.

The sulfide solid electrolyte in the present disclosure includes the crystal phase A as a main phase. “Including as a main phase” means that the proportion (weight %) of the crystal phase A with respect to all the crystal phases included in the sulfide solid electrolyte is the most. The proportion of the crystal phase A with respect to all the crystal phases included in the sulfide solid electrolyte is, for example, 50 weight % or more, may be 70 weight % or more, and may be 90 weight % or more. The proportion of the crystal phase A may be obtained from, for example, a result of a radiation XRD.

Also, in the sulfide solid electrolyte of the present disclosure, in an X-ray diffraction measurement using a CuKα ray, when I_{A} designates a peak intensity of Li₂S that appears at the position of 2θ=27.0°±0.5°, and I_{B} designates a peak intensity of the crystal phase A (crystal phase with Li₇P₃S₁₁ structure) that appears at the position of 2θ=23.65°±0.50°, I_{A}/I_{B} is the specified numerical value or less. Low I_{A}/I_{B} means that the amount of Li₂S component in the sulfide solid electrolyte is little. I_{A}/I_{B} is usually 3.9 or less, may be 3.0 or less, may be 2.0 or less, and may be 1 or less. Meanwhile, I_{A}/I_{B} may be 0 and may be larger than 0. Incidentally, in the present disclosure, when the sulfide solid electrolyte does not include the peak of Li₂S that appears at the position of 2θ=27.0°±0.5°, I_{A} becomes 0. “Not including the peak of Li₂S” means that the peak of Li₂S is too little to distinguish from surrounding noise. When the value of I_{A}/I_{B} is too large, that is, when the amount of Li₂S present is too much, there is a risk that the ion conduction may be inhibited or the generation amount of the hydrogen sulfide may increase. Also, it may be a cause of composition deviation.

Also, in the sulfide solid electrolyte of the present disclosure, in an X-ray diffraction measurement using a CuKα ray, a peak of a heterogeneous phase that appears at the position of 2θ=16.5°±0.5° is not included. The heterogeneous phase refers to a crystal phase that does not correspond to any of the unreacted raw materials and the crystal phase A, and it is a crystal phase with lower ion conductivity than that of the crystal phase A. “Not including the peak at the position of the heterogeneous phase” means that the peak of Li₂S is too little to distinguish from the surrounding noise. In specific, when I_{c} designates the peak intensity of the heterogeneous phase that appears at the position of 2θ=16.5°±0.5°, it means that I_{c}/I_{B} is 0.1 or less.

In the sulfide solid electrolyte, the molar ratio of S with respect to P, which is S/P is, for example, 3.60 or less, may be 3.2 or less, may be 3.0 or less, and may be 2.8 or less. Incidentally, the S/P in the conventional Li₇P₃S₁₁ crystal phase is 3.67. Meanwhile, the S/P is, for example, 2.0 or more and may be 2.2 or more.

In the sulfide solid electrolyte, the molar ratio of Li with respect to the total of Li and P, which is Li/(Li+P) is, for example, 0.65 or more, and may be 0.68 or more. Meanwhile, the Li/(Li+P) is, for example, 0.75 or less and may be 0.72 or less. Incidentally, the Li/(Li+P) in the conventional Li₇P₃S₁₁ crystal phase is 0.70. Also, when the sulfide solid electrolyte contains X (X is halogen), it is preferable that the Li excluding the Li equimolar with the X satisfies the relationship of the molar ratio Li/(Li+P).

It is preferable that the ion conductivity of the sulfide solid electrolyte is high. The ion conductivity at 25° C. is, for example, 0.11 mS/cm or more and may be 0.5 mS/cm or more. The ion conductivity of the sulfide solid electrolyte may be measured by, for example, an a.c. impedance method.

Examples of the shape of the sulfide solid electrolyte may include a granular shape. The average particle size (D₅₀) of the sulfide solid electrolyte is, for example, 0.1 μm or more and 50 μm or less. Also, the average particle size (D₅₀) may be obtained from the result of a particle distribution measurement by a laser diffraction scattering method. The application of the sulfide solid electrolyte is not particularly limited, but preferably used in an all solid state battery, for example.

B. Precursor

A precursor of a sulfide solid electrolyte in the present disclosure is the precursor of the above described sulfide solid electrolyte, and the precursor contains the Li, the P, the S and the CO₃²⁻, and a decarbonation amount measured from a thermal gravimetric—differential thermal analysis is in the specified range.

According to the present disclosure, the precursor contains CO₃²⁻ and the decarbonation amount is the specified range, and thus the precursor allows to obtain a sulfide solid electrolyte having excellent ion conductivity and water resistance.

The decarbonation amount is usually 0.49 weight % or more, may be 0.6 weight % or more, and may be 0.7 weight % or more. Meanwhile, the decarbonation amount is usually 1.36 weight % or less, may be 1.3 weight % or less, may be 1.1 weight % or less, and may be 0.9 weight % or less. The decarbonation amount is calculated from a thermal gravimetric—differential thermal analysis (TG-DTA).

Also, the precursor in the present disclosure is usually amorphous sulfide glass. Amorphous means that a so-called halo pattern is observed in an X-ray diffraction (XRD) measurement but no periodicity as a crystal is observed. Also, the precursor is usually used for obtaining the sulfide solid electrolyte described in “A. Sulfide solid electrolyte” above.

C. All Solid State Battery

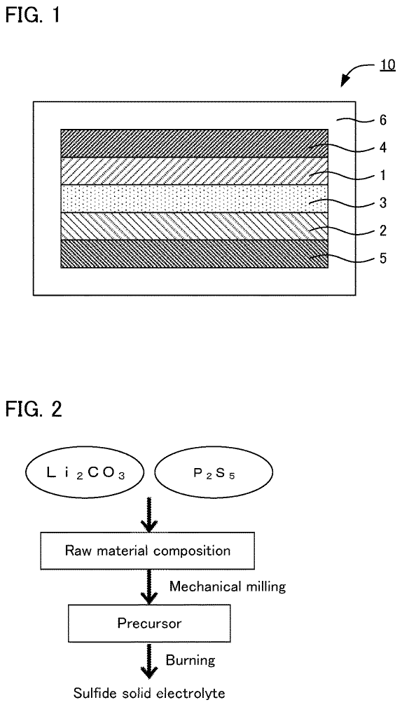

FIG. 1 is a schematic cross-sectional view illustrating an example of the all solid state battery in the present disclosure. All solid state battery 10 illustrated in FIG. 1 comprises cathode layer 1, anode layer 2, solid electrolyte layer 3 formed between the cathode layer 1 and the anode layer 2, cathode current collector 4 for collecting currents of the cathode layer 1, anode current collector 5 for collecting currents of the anode layer 2, and battery case 6 for storing these members. Further, at least one of the cathode layer 1, the anode layer 2, and the solid electrolyte layer 3 contains the sulfide solid electrolyte described in “A. Sulfide solid electrolyte” above.

According to the present disclosure, usage of the above described sulfide solid electrolyte allows an all solid state battery to have excellent ion conductivity and water resistance.

1. Cathode Layer

The cathode layer in the present disclosure is a layer containing at least a cathode active material. The cathode layer may contain at least one of a solid electrolyte, a conductive material, and a binder other than the cathode active material.

Examples of the cathode active material may include an oxide active material. Examples of the oxide active material may include a rock salt bed type active material such as LiCoO₂, LiMnO₂, LiNiO₂, LiVO₂, and LiNi_{1/3}Co_{1/3}Mn_{1/3}O₂; a spinel type active material such as LiMn₂O₄ and Li(Ni_{0.5}Mn_{1.5})O₄; and an olivine type active material such as LiFePO₄, LiMnPO₄, LiNiPO₄, and LiCuPO₄.

The surface of the cathode active material may be coated with a coating layer. The reason therefor is to inhibit the reaction of the cathode active material and the sulfide solid electrolyte. Examples of the materials of the coating layer may include a Li-ion conductive oxide such as LiNbO₃, Li₃PO₄, and LiPON. The average thickness of the coating layer is, for example, 1 nm or more and 20 μm or less, and may be 1 nm or more and 10 nm or less.

The cathode layer in the present disclosure preferably contains the above described sulfide solid electrolyte. In addition, examples of the conductive material may include a carbon material. Examples of the carbon material may include a particulate carbon material such as acetylene black (AB) and Ketjen black (KB), and a fiber carbon material such as carbon fiber, carbon nanotube (CNT), and carbon nanofiber (CNF). Examples of the binder may include a fluoride-based binder such as polyvinylidene fluoride (PVDF). The thickness of the cathode layer is, for example, 0.1 μm or more and 1000 μm or less.

2. Anode Layer

The anode layer in the present disclosure is a layer containing at least an anode active material. Also, the anode layer may contain at least one of a solid electrolyte, a conductive material, and a binder other than the anode active material.

Examples of the anode active material may include a metal active material and a carbon active material. Examples of the metal active material may include In, Al, Si, and Sn. Meanwhile, examples of the carbon active material may include methocarbon microbeads (MCMB), highly oriented pyrolytic graphite (HOPG), hard carbon, and soft carbon.

The solid electrolyte, the conductive material and the binder are in the same contents as those described above. The anode layer in the present disclosure preferably contains the above described sulfide solid electrolyte. The thickness of the anode layer is, for example, 0.1 μm or more and 1000 μm or less.

3. Solid Electrolyte Layer

The solid electrolyte layer in the present disclosure is a layer formed between the cathode layer and the anode layer, and contains at least a solid electrolyte. Also, the solid electrolyte layer may contain a binder other than the solid electrolyte. The solid electrolyte and the binder are in the same contents as those described above. The solid electrolyte layer in the present disclosure preferably contains the above described sulfide solid electrolyte. The thickness of the solid electrolyte layer is, for example, 0.1 μm or more and 1000 μm or less.

4. Other Constitutions

The all solid state battery in the present disclosure usually includes a cathode current collector for collecting currents of the cathode layer, and an anode current collector for collecting currents of the anode layer. Examples of the material for the cathode current collector may include SUS, aluminum, nickel, iron, titanium, and carbon. Meanwhile, examples of the material for the anode current collector may include SUS, copper, nickel, and carbon. Also, as a battery case, general battery cases such as a battery case made of SUS may be used.

5. All Solid State Battery

The all solid state battery in the present disclosure is preferably an all solid lithium ion battery. Also, the all solid state battery may be a primary battery and may be a secondary battery, but preferably a secondary battery among them. The reason therefor is to be repeatedly charged and discharged and useful as a car-mounted battery for example. Incidentally, the secondary battery includes the usage of the secondary battery as a primary battery (usage for the purpose of only one time discharge after charge). Also, examples of the shape of the all solid state battery may include a coin shape, a laminate shape, a cylindrical shape and a square shape.

D. Method for Producing Sulfide Solid Electrolyte

FIG. 2 is a flow-chart illustrating an example of the method for producing the sulfide solid electrolyte in the present disclosure. In FIG. 2, first, a raw material composition containing Li₂CO₃ and P₂S₅ is prepared. Next, a mechanical milling treatment is conducted to the raw material composition to obtain a precursor. Next, the obtained precursor is burned to form a crystal phase with Li₇P₃S₁₁ structure. Thereby, a sulfide solid electrolyte is obtained.

According to the present disclosure, by using the raw material composition containing Li₂CO₃ and forming the crystal phase with Li₇P₃S₁₁ structure, the sulfide solid electrolyte having excellent ion conductivity and water resistance may be obtained. Also, in the present disclosure, the above described sulfide solid electrolyte can be produced without or reduced amount of Li₂S that is expensive as a raw material, and thus the production cost may be reduced.

1. Amorphizing Step

An amorphizing step is a step of conducting a mechanical milling treatment to a raw material composition containing Li₂CO₃ and P₂S₅ to obtain a precursor.

The raw material composition contains at least Li₂CO₃ and P₂S₅. The raw material composition may or may not contain iLi₂S, but the latter is preferable. The reason therefor is to reduce the sulfur content of the sulfide solid electrolyte. Meanwhile, in the former case, the proportion of Li₂S with respect to the total of Li₂CO₃ and Li₂S is, for example, 50 mol % or less, may be 30 mol % or less, and may be 10 mol % or less. Meanwhile, the proportion is, for example, 1 mol % or more.

The raw material composition may further contain LiX (X is halogen). Examples of the LiX may include LiF, LiCl, LiBr, and LiI. In addition, the raw material composition may or may not contain an oxide such as Li₂O.

The molar ratio of S with respect to P, which is S/P in the raw material composition is, for example, 3.60 or less, may be 3.2 or less, may be 3.0 or less, and may be 2.8 or less. Incidentally, the S/P in the conventional Li₇P₃S₁₁ crystal phase is 3.67. Meanwhile, the S/P is, for example, 2.0 or more and may be 2.2 or more.

The molar ratio of Li with respect to the total of Li and P, which is Li/(Li+P) in the raw material composition is, for example, 0.65 or more and may be 0.68 or more. Meanwhile, the Li/(Li+P) is, for example, 0.75 or less and may be 0.72 or less. Incidentally, the Li/(Li+P) in the conventional Li₇P₃S₁₁ crystal phase is 0.70. Also, when the raw material composition contains X (X is halogen), it is preferable that the Li excluding the equimolar Li with X satisfies the relationship of the molar ratio Li/(Li+P).

Also, there are no particular limitations on the mechanical milling if it is a method that can apply mechanical energy, and examples thereof may include ball milling, vibration milling, turbo milling, mechano-fusion, and disc milling. The mechanical milling may be dry mechanical milling and may be wet mechanical milling, but the latter is preferable from the viewpoint of uniform treatment. There are no particular limitations on the kinds of a dispersion medium used for the wet mechanical milling.

Various conditions of the mechanical milling are respectively arranged so as to obtain the desired precursor. For example, when planetary ball milling is used, the raw material composition and balls for crushing thereof will be added, and the treatment will be conducted with a specific revolution speed and time. The weighing table revolution speed of the planetary ball milling is, for example, 300 rpm or more and may be 400 rpm or more. Meanwhile, the weighting table revolution speed of the planetary ball milling is, for example, 600 rpm or less and may be 550 rpm or less. Also, the treatment time of the planetary ball milling is, for example, 10 hours or more, may be 18 hours or more, and may be 20 hours or more. Meanwhile, the treatment time is, for example, 30 hours or less and may be 25 hours or less.

The precursor obtained by the amorphizing step is in the same contents as those described in “B. Precursor of sulfide solid electrolyte”; thus, the descriptions herein are omitted.

2. Burning Step

The burning step is a step of burning the precursor to form a crystal phase with Li₇P₃S₁₁ structure.

The burning temperature is preferably not less than a crystallization temperature (T_{c}) of the sulfide solid electrolyte to be obtained by burning the precursor. The crystallization temperature (T_{c}) of the sulfide solid electrolyte is, for example, 170° C. or more and 280° C. or less. The crystallization temperature (T_{c}) of the sulfide solid electrolyte can be obtained by a differential thermal analysis (DTA). The burning temperature is, for example, T_{c} or more. Also, the burning temperature is, for example, 200° C. or more and 320° C. or less.

The burning time is not particularly limited as long as the desired sulfide solid electrolyte is obtained. The burning temperature is, for example, 1 minute or more and 24 hours or less, and may be 1 minute or more and 10 hours or less. Also, the burning is preferably conducted in an inert gas atmosphere (such as an Ar gas atmosphere) or a reduced pressure atmosphere (such as in vacuum). The reason therefor is to prevent the sulfide solid electrolyte from deteriorating (such as oxidizing). There are no particular limitations on the method for the burning, and examples thereof may include a method using a burning furnace.

3. Sulfide Solid Electrolyte

The sulfide solid electrolyte containing Li, P, S and CO₃²⁻ can be obtained by the above described steps. The sulfide solid electrolyte is preferably in the same contents as those described in “A. Sulfide solid electrolyte” above.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

As raw materials, Li₂CO₃ (Kojundo Chemical Laboratory Co., Ltd.) and P₂S₅ (Aldrich) were used and a sulfide solid electrolyte was produced in the following manner. First, 0.8736 g of Li₂CO₃ and 1.1264 g of P₂S₅ were weighed and mixed. The obtained raw material composition (70Li₂CO₃-30P₂S₅) was put into a zirconium pot (45 ml) with zirconium balls having 5 mm diameter, 4 g of dehydrated heptane (Kanto Chemical Industry Co., Ltd.) was added thereto, and a lid was put on the pot. This pot was installed to a planetary ball milling device (Fritch P-7), mechanical milling was conducted at revolution speed of 500 rpm for 18 hours, and thereby a precursor (glass) was obtained. Next, burning was conducted by heating the obtained precursor at 300° C., which is the crystallization temperature or more, under an inert atmosphere for 3 hours. After that, the product was cooled to produce a sulfide solid electrolyte that was glass ceramic. Incidentally, when the obtained sulfide solid electrolyte was heated and the emitted gas was analyzed by gas chromatography, carbon dioxide was mainly detected. Therefore, it was confirmed that the sulfide solid electrolyte contained carbonate ion.

### Comparative Example 1

As raw materials, 0.6508 g of Li₂S (Furuuchi Chemical) and 1.3492 g of P₂S₅ were weighed and mixed. A sulfide solid electrolyte was produced in the same manner as in Example 1 except that the obtained raw material composition (70Li₂S-30P₂S₅) was used.

### Examples 2 to 3 and Comparative Examples 2 to 3

A sulfide solid electrolyte was produced in the same manner as in Example 1 except that the treatment time of the mechanical milling was respectively changed to the time shown in Table 1.

[Evaluation]

<Xrd Measurement>

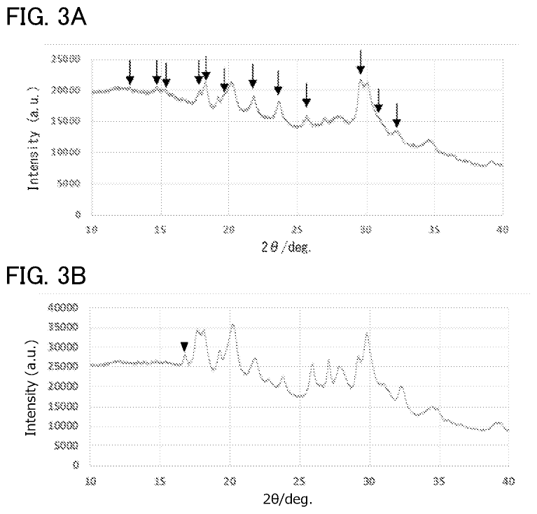

An X-ray diffraction (XRD) measurement using a CuKα ray was respectively conducted to the sulfide solid electrolytes obtained in Examples 1 to 3 and Comparative Examples 1 to 3. The results of Example 3 and Comparative Example 3 are shown in FIGS. 3A and 3B as representative results. As shown with arrow marks in FIG. 3A, the crystal phase with Li₇P₃S₁₁ structure was confirmed in Example 3. Also, the peak derived from the heterogeneous phase in the vicinity of 2θ=16.5° was not observed in Example 3. On the other hand, as shown in FIG. 3B, the peak derived from the heterogeneous phase in the vicinity of 2θ=16.5° was observed in Comparative Example 3. Also, I_{A}/I_{B} was respectively calculated from XRD charts, and the results were 0.39 in Example 3 and 1.41 in Comparative Example 3. Further, I_{c}/I_{B} was respectively calculated, and the results were 0.098 in Example 3 and 0.61 in Comparative Example 3.

<Thermal Gravimetric—Differential Thermal Analysis>

The crystallization temperature (T_{c}) and the decarbonation amount were respectively obtained by conducting a thermal gravimetric—differential thermal analysis (TG-DTA) to each of the precursor in Examples 1 to 3 and Comparative Examples 1 to 3 in the following manner. Regarding the decarbonation amount, the temperature of the precursor was respectively raised from a room temperature to 400° C. at 10° C./min using a TG-DTA device (from Rigaku), and the decarbonation amount was calculated from TG curves of before and after the crystallization temperature. The results are shown in Table 1.

<Ion Conductivity Measurement>

An ion conductivity measurement (25° C.) was respectively conducted to the sulfide solid state electrolytes obtained in Examples 1 to 3 and Comparative Examples 1 and 3. The obtained sulfide solid electrolyte in powder 100 mg was pressed at the pressure of 6 ton/cm² using a pellet molding machine to produce pellet. The resistance of the pellet was obtained from an a.c. impedance method, and the ion conductivity was obtained from the thickness of the pellet. The results are shown in Table 1.

<Hydrogen Sulfide Generation Amount Measurement>

The water resistance was respectively evaluated by measuring the hydrogen sulfide generation amount of the sulfide solid electrolytes obtained in Example 2 and Comparative Example 1 in the following manner. A desiccator of 1.5 L was put in a dry air glove box set to a dew point of −30° C., an Al container with the sulfide solid electrolyte weighed to 2 mg was placed in the desiccator, the lid of the desiccator was closed with the fan turned on, and exposed for 30 minutes. The hydrogen sulfide generated on this occasion was observed by a sensor. The results are shown in Table 1.

TABLE 1

| | | | | De- | Con- | H₂S | |
|---|---|---|---|---|---|---|---|
| | | Treat- | | carb- | duc- | gen- | |
| | Raw | ment | | onation | tivity | eration | |
| | material | time | Tc | amount | (mS/ | amount | I_{A}/ |
| | composition | (hr) | (° C.) | (wt %) | cm) | (ppm) | I_{B} |
| Comp. | 70Li₂S—30P₂S₅ | 20 | 254 | — | 1.8 | >100 | — |
| Ex. 1 | | | | | | | |
| Comp. | 70Li₂CO₃—30P₂S₅ | 10 | 287 | 12.04 | 0.025 | — | — |
| Ex. 2 | | | | | | | |
| Ex. 1 | 70Li₂CO₃—30P₂S₅ | 18 | 286 | 1.36 | 0.13 | — | — |
| Ex. 2 | 70Li₂CO₃—30P₂S₅ | 20 | 286 | 0.71 | 0.23 | 0.4 | — |
| Ex. 3 | 70Li₂CO₃—30P₂S₅ | 25 | 287 | 0.49 | 0.11 | — | 0.39 |
| Comp. | 70Li₂CO₃—30P₂S₅ | 30 | 288 | 0.43 | 0.052 | — | 1.41 |
| Ex. 3 | | | | | | | |

As shown in Table 1, although the ion conductivity of Comparative Example 1 was high, the hydrogen sulfide generation amount was large. On the other hand, excellent ion conductivity of 10⁻¹ mS/cm or more was respectively obtained in Examples 1 to 3. Also, the hydrogen sulfide generation amount of Example 2 was remarkably lower than that of Comparative Example 1. Although the hydrogen sulfide generation amount of Examples 1 and 3 was not measured, the result similar to that of Example 2 is presumably obtained since the raw material composition is the same.

Also, the ion conductivity of Comparative Example 2 and Comparative Example 3 was respectively lower than that of Examples 1 to 3. Also, the decarbonation amount of Comparative Example 2 was extremely large. This is presumably because the treatment time is short and the carbonate ion was not taken into the glass. In this manner, it was suggested that the sulfide solid electrolyte obtained in Comparative Example 2 did not contain carbonate ion (CO₃²⁻). Also, the ion conductivity of Comparative Example 2 was one-digit smaller compared to that of Examples 1 to 3. For this reason, it was suggested that the sulfide solid electrolyte obtained in Comparative Example 2 did not include the crystal phase with Li₇P₃S₁₁ structure. On the other hand, as shown in Table 1, since I_{A}/I_{B} of Comparative Example 3 was larger than that of Example 3, it was suggested that the water resistance was low. Also, the peak of the heterogeneous phase was confirmed in Comparative Example 3, and thus it was presumed that the ion conductivity was degraded due to the heterogeneous phase.

### REFERENCE SIGNS LIST

1 cathode layer
2 anode layer
3 solid electrolyte layer
4 cathode current collector
5 anode current collector
6 battery case
10 all solid state battery

What is claimed is:

1. A sulfide solid electrolyte comprising Li, P, S and CO₃²⁻; wherein
the sulfide solid electrolyte includes a crystal phase with Li₇P₃S₁₁ structure as a main phase;
in an X-ray diffraction measurement using a CuKα ray, when I_{A} designates a peak intensity of Li₂S that appears at the position of 2θ=27.0°±0.5°, and I_{B} designates a peak intensity of the crystal phase that appears at the position of 2θ=23.65°±0.50°, I_{A}/I_{B} is 0 or more and 0.39 or less; and
a peak of a heterogeneous phase that appears at the position of 2θ=16.5°±0.5° is not included.

2. The sulfide solid electrolyte according to claim 1, wherein a molar ratio of the S with respect to the P, which is S/P is 3.60 or less.

3. The sulfide solid electrolyte according to claim 1, wherein ion conductivity at 25° C. is 0.11 Ms/cm or more.

4. A precursor of the sulfide solid electrolyte according to claim 1; wherein
the precursor contains the Li, the P, the S and the CO₃²⁻; and
a decarbonation amount measured from a thermal gravimetric—differential thermal analysis is 0.49 weight % or more and 1.36 weight % or less.

5. An all solid state battery comprising a cathode layer, an anode layer, and a solid electrolyte layer formed between the cathode layer and the anode layer; wherein
at least one of the cathode layer, the anode layer, and the solid electrolyte layer contains the sulfide solid electrolyte according to claim 1.

6. A method for producing a sulfide solid electrolyte containing Li, P, S and CO₃²⁻, the method comprising:
an amorphizing step of conducting a mechanical milling treatment to a raw material composition containing Li₂CO₃ and P₂S₅ to obtain a precursor; and
a burning step of burning the precursor to form a crystal phase with Li₇P₃S₁₁ structure.

7. The method for producing the sulfide solid electrolyte according to claim 6, wherein the precursor contains the Li, the P, the S and the CO₃²⁻, and a decarbonation amount measured from a thermal gravimetric—differential thermal analysis is 0.49 weight % or more and 1.36 weight % or less.

8. The method for producing the sulfide solid electrolyte according to claim 6, wherein the mechanical milling treatment in the amorphizing step is planetary ball milling, weighing table revolution speed is 400 rpm or more and 600 rpm or less, and treatment time is 18 hours or more and 25 hours or less.

9. The method for producing the sulfide solid electrolyte according to claim 6, wherein the raw material composition does not contain Li₂S.
